(19) United States
(12) Patent Application Publication
(10) Pub. No.: US 2009/0218919 A1
(43) Pub. Date: Sep. 3, 2009

(54) Carrying Structure for Furniture, Especially for Kitchen Furniture or the Like

(75) Inventor: Roberto Sabatini, Modena (IT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: GLEM GAS S.P.A.

(21) Appl. No.: 12/224,131

(22) PCT Filed: Jun. 27, 2006
(86) PCT No.: PCT/IB2006/001759

§ 371 Date: Oct. 14, 2008

(30) Foreign Application Priority Data
Feb. 21, 2006 (IT) MO2006A000057

(51) Int. Cl. F16B 12/00

(52) U.S. Cl. 312/111

(57) ABSTRACT

The present invention refers to a carrying structure for furniture, especially for kitchen furniture or the like, comprising a plurality of modular elements featuring at least two uprights and at least one crosspiece associated with said uprights by placing temporary fastening means in between, the modular elements being associated with each other in a removable way so as to delimit at least one housing compartment for kitchen equipment or the like, and to support at least one substantially horizontal supporting and/or work top.

### TECHNICAL FIELD

The present invention refers to a carrying structure for furniture, especially for kitchen furniture or the like.

### BACKGROUND ART

With special reference to the interior decorating industry, the use is known of modular kitchens consisting of distinct modules such as, for instance, door units, units with drawers or baskets, wall units, units for supporting household appliances, sinks, cooktops, etc.

Such modules normally consist of panels fastened together by means of adhesives or the like to define a compartment able to accommodate kitchen equipment such as household appliances (oven, dishwasher), or support shelves, baskets, drawers, etc.

The known modules can be fitted together and arranged so as to define predetermined types of configurations, depending on the conformation of the interior to be furnished and specific aesthetic choices (either made during manufacture or by the end user).

These known kitchens are not without drawbacks, including the fact that, though different variations are in general available, with different measurements and overall dimensions of the single modules, the possible configurations are however limited and not always perfectly adaptable to the interiors to be furnished or specific aesthetic requirements of the user.

Furthermore, the presence of modules of pre-defined dimensions reduces the use of the inner compartment of the furniture units and restricts the relevant storage capacity.

A further drawback of known kitchens is the difficulty in carrying out accurate cleaning operations, due in particular to the presence of spaces between the assembled modules, inside which dust and dirt in general gather. To perform such cleaning operations, which are especially important for maintaining a suitable standard of hygiene inside an environment where food is prepared and cooked, the modules do in fact have to be separated and this operation is hard to do in the case of already-assembled kitchens.

Furthermore the woody composition of the panels generally used to make the modules requires the limited use of water during cleaning operations so as to avoid infiltrations between one panel and another or inside the panels themselves, with the consequent possibility of swelling and/or the generation of mildew.

In particular, close to sinks and household appliances such as refrigerators, washing machines, dishwashers, etc., where the leaking of water and steam is frequent, the formation of swelling and mildew is very frequent.

In fact, the woody panels normally used, even when they are defined as “water repellent”, are in any case partially subject to infiltration, especially at the joints between the surfaces and side edges of two panels.

Another drawback consists in the difficulty during packaging, transport and assembly, due to the far-from-negligible overall dimensions of the single modules.

To the above drawbacks must be added the fact that each module consists, in general, of numerous panels (for example with a woody base) fastened together using potentially polluting adhesives that are harmful to people's health. To make these modules in fact, resins are commonly used deriving from substances like formaldehyde, currently considered one of the most common pollutants of interiors. Molecules of formaldehyde are in fact released over time inside the environment and, though it is commonly thought that its concentration inside buildings is normally sufficiently reduced, prolonged exposure to large quantities or accidental swallowing can seriously affect people's health.

Known kitchens are generally made of materials that are not fireproof, with increased risk of accidental fires, also in view of the presence of household appliances such as cooktops, ovens or the like.

### DISCLOSURE OF THE INVENTION

The main aim of this invention is to eliminate the problems complained of above and associated with the known state of the art and to excogitate a carrying structure for furniture, especially for kitchen furniture or the like, which is versatile and adaptable to any type of environment or any type of aesthetic requirement.

Within the scope of such technical aim, another purpose of the invention is to permit the sizing of the interior compartment in relation to specific storage requirements.

Another purpose of the invention is to make cleaning easier so as to maintain an adequate standard of hygiene inside the environment.

Another objective of the invention is to make a water-repellent structure which is not therefore liable to the damage notoriously caused by infiltrations and the presence of steam.

Another purpose of the invention is to make kitchen packaging and transport operations easier.

Another purpose of the invention is to avoid the use of polluting substances normally used to make kitchen furniture.

Not the last purpose is to make a furniture structure that reduces the possibility of accidental fires or, in any case, limits their effects.

This aim and these purposes are all achieved by this carrying structure for furniture, especially for kitchen furniture or the like, characterized by the fact that it comprises a plurality of modular elements featuring at least two uprights and at least one crosspiece associated with said uprights by placing temporary fastening means in between, said modular elements being associated with each other in a removable way so as to delimit at least one housing compartment for kitchen equipment or the like, and to support at least one substantially horizontal supporting and/or work top.

### BRIEF DESCRIPTION OF THE DRAWINGS

Further characteristics and advantages of the present invention will appear even more evident from the detailed description of a preferred, but not exclusive, form of embodiment of a carrying structure for furniture, especially for kitchen furniture or the like, illustrated by way of non limiting example in the accompanying drawings, wherein:

FIG. 1 is an axonometric view of the structure according to the invention;

FIG. 2 is a side view of a modular element of the structure according to the invention;

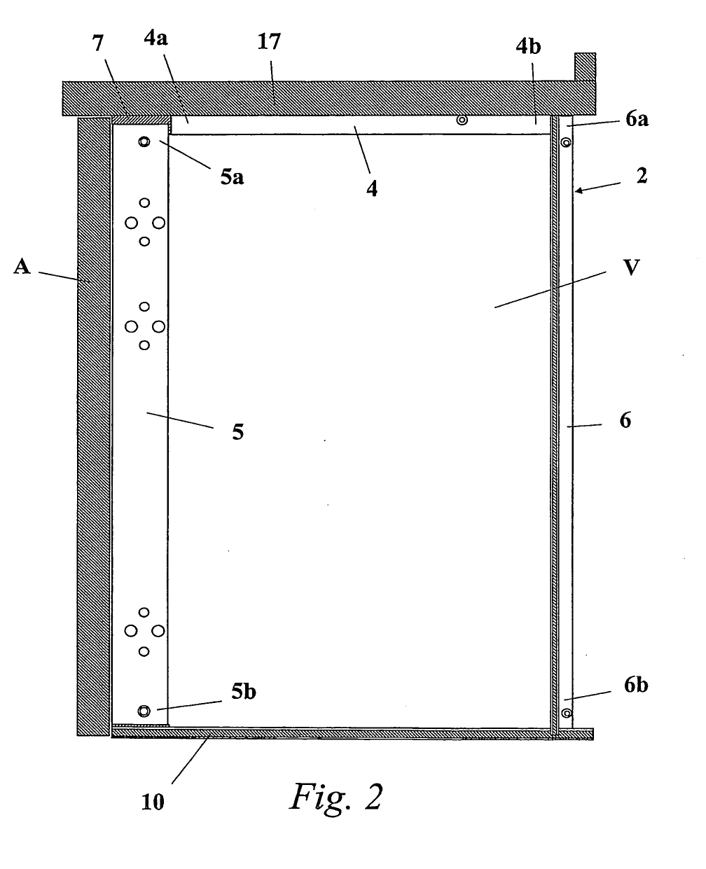

FIGS. 3 and 4 are section views of a modular element of the structure according to the invention;

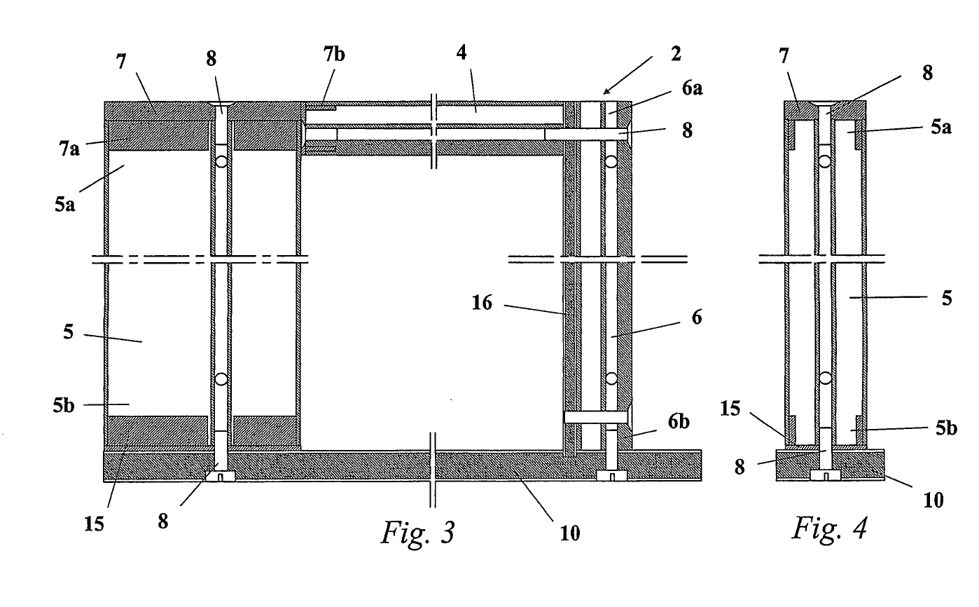

FIGS. 5, 6 and 7 are views of a part of the modular element.

### WAYS OF CARRYING OUT THE INVENTION

With special reference to such figures, a carrying structure for furniture, especially to be employed in the kitchen furnishing industry, has been generally designated by reference numeral 1.

Structure 1 comprises a plurality of modular elements 2, each of which featuring a pair of uprights 3 and a crosspiece 4. The crosspiece 4 has its ends associated with the uprights 3 by means of the interposition of temporary fastening means.

More specifically, each of the modular elements 2 comprises a front upright 5 and a rear upright 6, where the words “front” and “rear” refer, in this description and in a non-exclusive way, to the normal layout of the structure 1 after this has been positioned to furnish an interior.

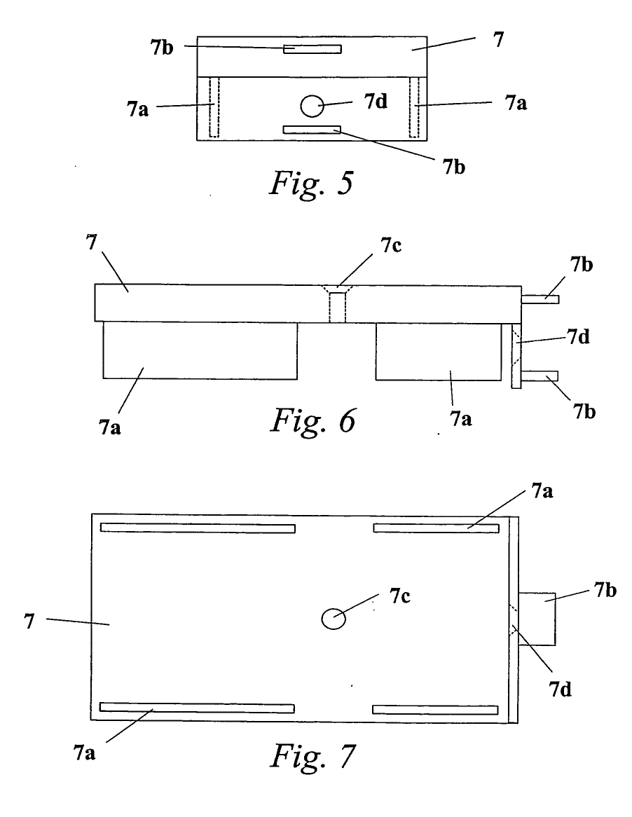

As shown in FIGS. 5, 6 and 7, the temporary fastening means comprise a first joint 7, featuring a pair of lower protruding elements 7a and a pair of rear protruding elements 7b. The particular tubular configuration, open at the ends, of the uprights 3 and the crosspiece 4 permits the slotting in of the lower protruding elements 7a inside the opening defined at the upper end 5a of the front upright 5, and of the rear protruding elements 7b inside the opening defined at the front end 4a of the crosspiece 4 respectively. The fastening of the upper end 5a and front end 4a to the first joint 7 is done by means of threaded means 8 of the type commonly used, screws or the like, applied to an upper through hole 7c and a rear through hole 7d on first joint 7 respectively.

The rear end 4b of the crosspiece 4 is fastened to the upper end 6a of the rear upright 6 by means of respective threaded means 8.

Other configurations of first joint 7, uprights 3 and the relevant crosspiece 4 are however not to be ruled out.

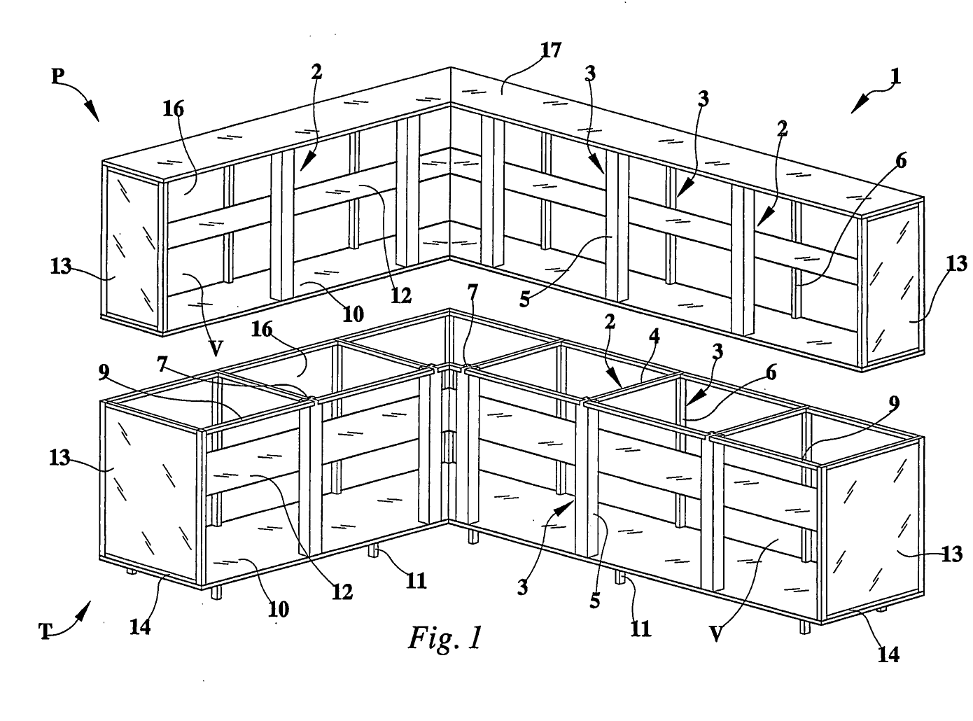

As shown in FIG. 1, the modular elements, suitably sized and conformed, can be associated with one another to make a hanging structure P or, alternatively, a ground structure T, both commonly used to furnish kitchens or the like.

With special, but not exclusive, reference to the ground structure T shown in FIG. 1, the modular elements 2 are associated with one another in a removable way by interposing cross connection elements 9, to delimit, below crosspieces 4, a compartment V for housing kitchen equipments or the like (such as, for instance, household appliances or kitchen implements).

In particular, each of the cross connection elements 9 consists of a small crosspiece with ends associated with the front uprights 5 of two modular elements 2 which succeed one another at the respective first joints 7.

A lower top 10 is associated by horizontal arrangement at the lower ends 5b and 6b, of the front uprights 5 and of the rear uprights 6 respectively to define a supporting base for the kitchen implements (or other equipment) arranged inside the compartment V.

Advantageously, the lower top 10 features ground supporting feet 11.

Usefully, the front uprights 5 and the rear uprights 6 can comprise supporting means for an intermediate top 12, arranged horizontally inside compartment V, at a substantially middle section of the uprights.

With special reference to the outer side ends of the structure 1, the modular elements 2 can comprise side panels 13 arranged vertically and able to laterally delimit the compartment V.

Each of the side panels 13 is fastened, by means of the threaded means 8 to the front and rear uprights 5 and 6 of the respective modular element 2.

Such outer modular elements 2 can comprise a further lower crosspiece 14; in the same way as seen for the crosspiece 4, the lower crosspiece 14 has its front end associated with a second joint 15 arranged at the lower end 5b of the front upright 5, and the rear end associated with the rear upright 6 at the lower end 6b. Fastening of the front and rear ends and of the lower crosspiece 14 is done by means of respective threaded means 8.

Further side panels 13 can be associated with the modular elements 2 arranged inside the structure 1, to define a plurality of compartments V, each one separate from the other.

Usefully, one or more rear panels 16 can be associated with the modular elements 2, at the respective rear uprights 6, for the rear closing of the compartment V (at the portion of the structure 1 which commonly faces onto and is adjacent to a wall of the interior to be furnished).

An upper top 17 is associated in a removable way with the modular elements 2, resting on the crosspieces 4 and on the small crosspieces 9, and extends horizontally along the entire ground structure T to define a supporting and/or work top, for instance, for the preparation of food. The upper top 17 can be made in a single body or as several distinct sections positioned alongside each other.

Advantageously, to the front uprights 5 hinging means of a door A can be associated able to open and close the compartment V, or alternatively, both the front uprights 5 and the respective rear uprights 6 can support straight guide means of a sliding element, for example, of a basket or a drawer type.

Similarly to what was seen above for the ground structure T, the hanging structure P comprises respective lower tops 10, intermediate tops 12 and upper tops 17, side panels 13, rear panels 16, as well as, if necessary, hinging means and straight guide means supported by the uprights 3.

The hanging structure P can comprise a supporting column, fastened to a wall of the interior to be furnished, and means, of the traditionally used type, for fastening the rear uprights 6 to such column.

Advantageously, the single modular elements 2 or the entire structure 1 can be made using materials of the metal, fireproof and water-repellent type.

Practically speaking, it has been found how the invention described reaches the proposed aims, and, in particular, the fact is underlined that the presence of the modular elements which can be associated the one with the other permits obtaining an extremely versatile structure that is easily adaptable to any type of interior, both in terms of measurements and different layouts.

The extreme modularity of the structure also permits proposing a broad range of solutions able to cater for even much differing aesthetic requirements.

The size of the internal compartment or compartments can also be as required to satisfy specific storage capacity needs.

It should also be noticed that once assembled, the structure is easy to clean and without the spaces usually found between the modules of traditional modular kitchens and which gather up dust or dirt that is hard to remove.

To this must be added the fact that the manufacture of the modular elements and, if necessary, of the panels using materials of a metal, fireproof and water-repellent type, makes the structure considerably longer lasting and less liable to damage compared to modules of known type and eliminates, for example, problems tied to water infiltration and limits the effects in case of accidental fires breaking out.

The high modularity of the structure also, in a far from negligible way, ensures easier packaging operations and permits reduced overall dimensions during transport.

The manufacture of the elements making up the structure in materials of the metal type, together with assembly using slot-in and/or threaded fastening means permits avoiding the use of commonly used and potentially polluting resins or adhesives.

The invention thus conceived is susceptible of numerous modifications and variations, all of which falling within the scope of the inventive concept.

Furthermore all the details can be replaced with others that are technically equivalent.

In practice, the materials used, as well as the shapes and dimensions, may be any according to requirements without because of this moving outside the protection scope of the following claims.

1-17. (canceled)

18. Carrying structure (1) for kitchen furniture, comprising:
a plurality of modular elements (2), each featuring at least two uprights (3), respectively a front upright (5) and a rear upright (6), and at least one crosspiece (4) associated with said two uprights (5, 6) by placing a temporary fastening arrangement (7, 7a, 7b, 8) in between, and
at least one substantially continuous horizontal lower top (10) associated with lower ends (5b, 6b) of the uprights (5, 6) of said plurality of modular elements (2),
wherein said modular elements (2) are arranged at the lower ends (5b, 6b) of the respective uprights (5, 6) on and supported by said at least one substantially horizontal lower top (10) and are associated with each other in a removable way by interposing cross connection elements (9) so as to delimit, below said crosspieces (4), at least one housing compartment (V) for kitchen equipment, and to support at least one substantially horizontal supporting and/or work top, and
wherein each said cross connection element comprises at least one small crosspiece (9) which is interposed between two succeeding front uprights (5) of two modular elements (2) which succeed one another on said at least one substantially horizontal lower top (10), with the ends of said small crosspiece (9) being associated with said two succeeding front uprights (5) at the respective fastening arrangement (7) with the crosspiece (4) of the corresponding modular element (2),
whereby said carrying structure (1) is adaptable to any type of interior to be furnished, as corresponding to said at least one substantially horizontal lower top (10), both in terms of measurements and different layouts,
wherein said temporary fastening arrangement comprise at least one joint (7) which can be slotted in between an upper end (5a) of at least one (5) of said uprights, in particular of said front upright (5), and a front end (4a) of said crosspiece (4), said joint (7) featuring at least one lower protruding element (7a) and at least one rear protruding element (7b),
wherein the uprights (3, 5, 6) and the crosspiece (4) have a tubular configuration, open at the ends, so as to permit the slotting in of the lower protruding element (7a) of said joint (7) inside the opening defined at the upper end (5a) of the front upright (5) and the slotting in of the rear protruding element (7b) of said joint (7) inside the opening defined at the front end (4a) of said crosspiece (4).

19. The carrying structure according to claim 18, wherein said temporary fastening arrangement comprise threaded elements (8) able to fasten the upper end (5a) of said front upright (5) and the front end (4a) of said crosspiece (4) to said joint (7), and to fasten the rear end (4b) of the crosspiece (4) to the upper end (6a) of said rear upright (6).

20. The carrying structure according to claim 18, wherein the modular elements (2) arranged at the outer sides of said carrying structure (1) comprise a further lower crosspiece (14) that is associated at its front end with a further joint (15) arranged at the lower end (5b) of the front upright (5), and is associated at its rear end with the lower end (6b) of the rear upright (6) of the modular element (2).

21. The carrying structure according to claim 18, wherein said joint (7) features a pair of lower protruding elements (7a) and a pair of rear protruding elements (7b), which pairs are suitable to be slotted in inside the opening defined at the upper end (5a) of said front upright (5) and respectively inside the opening defined at the front end (4a) of said crosspiece (4).

22. The carrying structure according to claim 18, comprising at least one substantially horizontal upper top (17), associated with at least one of said modular elements (2) in a removable way and resting on said crosspiece (4).

23. The carrying structure according to claim 22, where said supporting and/or work top is defined by said upper top (17).

24. The carrying structure according to claim 18, wherein at least one of said uprights comprises supporting elements of at least one intermediate top (12), substantially horizontal and arranged inside said compartment (V), at a substantially middle section of said uprights (5, 6).

25. The carrying structure according to claim 24, wherein said supporting and/or work top is defined by said intermediate top (12).

26. The carrying structure according to claim 18, wherein at least one of said uprights (5, 6) comprises hinging elements of at least one door able to open and close said compartment.

27. The carrying structure according to claim 18, wherein at least one of said uprights comprises straight guide arrangement of at least one sliding element along a substantially horizontal direction.

28. The carrying structure according to claim 27, wherein said sliding element is of a basket, a drawer type or the like.

29. The carrying structure according to claim 18, wherein at least one of said modular elements (2) comprises a side panel (13) arranged substantially vertical and associated in a removable way with at least one between said uprights (5, 6) and said crosspiece (4).

30. The carrying structure according to claim 18, comprising at least one rear panel (16) associated in a removable way with at least one of said modular elements (2), by at least one of said uprights.

31. The carrying structure according to claim 18, wherein said supporting and/or work top is defined by said lower top (10).

32. The carrying structure according to claim 18, wherein said modular elements (2) are made using materials of the metal type.

33. The carrying structure according to claim 18, wherein said modular elements (2) are made using materials of the water-repellent type.

34. The carrying structure according to claim 18, wherein said modular elements (2) are made using materials of the fireproof type.

35. The carrying structure according to claim 18, wherein said carrying structure exhibits at least two portions, as defined by said horizontal lower top (10) and by said modular elements (2), which are reciprocally arranged according to an angled configuration.

36. The carrying structure according to claim 18, wherein said at least one substantially horizontal lower top (10) features ground supporting feet (11) at positions which are different from and not aligned with those of the lower ends (5b, 6b) of said uprights (5, 6), whereby said modular elements (2) are arranged on and supported by said at least one substantially horizontal lower top (10) independently from said ground supporting feet (11).
